(19) United States
(12) Patent Application Publication
(10) Pub. No.: US 2026/0002581 A1
(43) Pub. Date: Jan. 1, 2026

(54) BALL SCREW DRIVE WITH INTERNAL DEFLECTOR

(71) Applicant: SFS Group International AG, Heerbrugg (CH)

(72) Inventors: Daniel SINZ, Kennelbach (AT); Jasmin HANSELMANN, Altstätten (CH); Marijo ZACH, Widnau (CH); Sebastian SPIRIG, Widnau (CH)

(73) Assignee: SFS Group International AG, Heerbrugg (CH)

(21) Appl. No.: 19/250,402

(22) Filed: Jun. 26, 2025

(30) Foreign Application Priority Data
Jun. 28, 2024 (EP) 24185412.4

(51) Int. Cl. F16H 25/22

(52) U.S. Cl. CPC F16H 25/2228

(57) ABSTRACT

A ball screw drive having a threaded spindle, a spindle nut and balls which circulate in a helical ball race located therebetween. Two ball deflectors engage in the ball race and a transfer channel extends therebetween that together with part of the ball race form a closed recirculation track. The ball return guide is an internal deflector. The threaded spindle includes a radially external hollow cylinder with a central symmetrical internal cavity and a cylindrical core filling this cavity. The cylindrical core is formed of first and second core halves. The transfer channel is arranged in the common separating surface of the core halves, which are designed as oblique halves, the common separating surface thereof forming a plane which intersects the central axis of the core only at one point. The ball screw drive can be used in a brake booster system, a wheel brake or generally as an actuator.

### CROSS-REFERENCE TO RELATED APPLICATIONS

This application claims priority from European Patent Application No. 24185412.4, filed Jun. 28, 2024, which is incorporated herein by reference as if fully set forth.

### TECHNICAL FIELD

The present invention relates to a ball screw drive comprising a specifically designed threaded spindle with an internal deflector, and the use of such a ball screw drive.

### BACKGROUND

A roller screw drive with balls as the rolling bodies is generally denoted as a ball screw or also as a ball screw drive. The main constituent parts of a ball screw drive include a threaded spindle and a spindle nut which encompasses this spindle. During operation, balls circulate between these two components. The thread flights of the threaded spindle and the spindle nut are configured as ball grooves with a suitable profile and are adapted to one another in a complementary manner such that between one another they form a ball race or a ball guide in the assembled state. In contrast to a screw-nut connection in which the thread flanks slide on one another in a planar manner, in the ball screw drive the circulating balls in the thread undertake the transfer of the load between the nut and spindle. The planar sliding movement is thus replaced by a rolling movement which is associated with reduced friction.

Ball return guides are used in order to obtain a closed recirculation track for the balls. These ball return guides are composed of two ball deflectors and a transfer channel located therebetween. The ball deflectors have the task of lifting the balls out of the ball race between the spindle nut and the threaded spindle at a first location and feeding the balls back at a second location. A ball return guide thus represents as a whole a bypass which bridges one or more thread flights of the nut-spindle system and thus forms a closed recirculation track for the balls of a ball screw drive. Generally, the balls in the spindle nut are lifted radially outwardly from the ball groove and guided in a channel or a tube (the transfer channel) inside or outside the spindle nut (external deflector) before they are inserted back into the ball race between the threaded spindle and the spindle nut at the location provided therefor.

However, ball screw drives are also known with an internal deflector in which the balls are also removed from the ball guide between the spindle nut and the threaded spindle at a first location and returned again at a second location. Instead of being guided radially outwardly into the spindle nut, however, the balls are guided radially inwardly into the threaded spindle and deflected therein.

In both cases, the forces which are released when the balls are lifted out from the ball guide have to be absorbed or deflected by the ball deflector.

From a technical perspective, a ball screw drive operates as a screw drive which can convert a rotational movement into a longitudinal movement, or vice versa. The step-down ratio or step-up ratio is determined by the dimensioning of the threaded spindle and the pitch of the thread.

Ball screw drives are used in many technical applications, where a longitudinal movement is intended to be achieved by an electric motor and not via a hydraulically or pneumatically operated cylinder. Ball screw drives play an increasing role in electromechanical and electrohydraulic braking systems, where ball screw drives are used as a replacement for hydraulically actuated brake cylinders or in brake assistance systems in parallel with known braking systems. In this case, they help to increase the braking force of a driver or to introduce or assist an (emergency) braking procedure as part of a safety system. Purely electrically operated braking systems with ball screw drives are thus also possible as a replacement brake cylinder on each wheel.

It is a fundamental problem in ball screw drives that, in particular with an external deflector, the ball return guides increase the external diameter and thus the volume of the component. Moreover, a transfer channel which is attached externally to the (generally cylindrical) spindle unit frequently impedes the compact integration in a drive system. Although there are ball screw drives of which the transfer channels are able to be accommodated in a recessed manner in the cylinder wall of the spindle nut; this design also requires a corresponding wall thickness of the spindle nut which is not always possible or desired, however.

### PRIOR ART

Ball screw drives with an internal deflector have already been described in detail in the 1960s, for example in U.S. Pat. No. 3,333,484.

A further publication from the prior art is DE 27 41 333. In this case, a ball return guide deflects the balls such that they are radially deflected into a cylindrical core inside the threaded spindle, they are guided in the central plane of the core and they are guided back again radially outwardly. This produces an S-shaped or U-shaped transfer channel. If the core is designed from two half-shells, the transfer channel can be guided in the parting plane of the half-shells.

DE 10 2015 109 159 A1 discloses a ball screw drive, the threaded spindle thereof having an axial bore and two slot-shaped indentations which are incorporated at two defined points on the thread of the threaded spindle and which extend as far as the longitudinal channel of the central bore. The two slot-shaped indentations are provided for receiving ball deflectors which deflect the balls radially inwardly out of the ball race into the axial transfer channel or guide the balls out of the transfer channel back into the ball race.

An internal deflector is disclosed in DE 10 2016 013 356, the deflection channel thereof not running within, but parallel to, the central axis. The threaded spindle is designed in two parts, with a radially external tubular part and a radially internal core which fills the cylindrical interior of the hollow cylinder. The transfer channel is arranged in the core.

### SUMMARY

The application is based on the object of developing the principle of the internal deflector relative to safety of use and ease of assembly.

This object is achieved by one or more of the features described herein. Advantageous embodiments of the invention are specified below and in the claims.

A ball screw drive in a generic design similar to the prior art set forth above comprises a threaded spindle and a spindle nut which at least partially coaxially encloses the threaded spindle. A plurality of balls circulate in the intermediate space between the threaded spindle and the spindle nut in a helical ball race. This ball race is formed from two raceways which face one another, wherein one raceway is arranged on the inner face of the spindle nut and the other raceway is arranged on the outer face of the threaded spindle. A ball screw drive can comprise one or more ball return guides. Such a ball return guide has two ball deflectors engaging in the ball race and a transfer channel which runs therebetween. Thus, together with a portion of the ball race, a closed recirculation track is formed for the balls. Ball return guides which are designed in such a manner always bridge more than one winding of the helical ball race.

In the present invention, the ball return guide is designed as an internal deflector with a transfer channel oriented toward the central axis. “Toward the central axis” means that in principle the transfer channel runs inside the threaded spindle and does not have to be designed such that it can only be arranged directly in the region between the ball deflector(s) and the central axis.

The threaded spindle comprises at least in some portions a radially external hollow cylinder with a central symmetrical internal cavity and a cylindrical core filling this cavity. “At least in some portions a radially external hollow cylinder” is to be understood to mean that the threaded spindle can have both the basic shape of a sleeve which is open on both sides and that of a hollow cylinder which is open only on one side. As a result, “cavity” is understood to mean the interior of the hollow cylinder and “core” is understood to mean a cylindrical component to be introduced into this cavity.

This cylindrical core of the threaded spindle is composed of a first and a second core half. Said transfer channel between the ball deflectors is arranged in the common separating surface of the two core halves.

According to the invention, the two core halves are designed as oblique halves. “Oblique” is understood to mean that the separating surface intersects the core substantially diagonally. In mathematical terms, the common separating surface defines a plane which intersects the central axis of the core only at one point. In particular, the central axis of the threaded spindle is not located in the separating surface but intersects it at one point, and only at one point.

It is achieved by the selected design that the direction of the deflection of the balls out of the ball race into the transfer channel is substantially configured as a secant (in the separating surface). This means that the initial direction of the balls immediately after the deflection inwardly does not run radially to the central axis but follows a secant, i.e. away from the deflection point and past the central axis. This secant, for technical reasons, transitions into an arcuate path in the direction of the second ball deflector. The transfer channel and the ball deflectors in turn are preferably symmetrically designed so that the forces arising when the balls are ejected or introduced are independent of the rotational direction of the ball screw drive.

In a ball screw drive of the design described herein, the hollow cylinder of the threaded spindle will have through-passages at those locations where the positions of the ball deflectors are provided. As is familiar to a person skilled in the art, the through-passages are placed such that they lead precisely into a ball race between the threaded spindle and spindle nut. At precisely these locations, the balls can be removed from the ball race or fed back therein.

Due to the above-described construction of the core, the transfer channel is thus preferably constructed from two half-shell raceways and thus in each case they form one groove-shaped half of the transfer channel. The half-shell raceways are located in the surfaces of the two core halves which face the separating surface and in the joined-together state complement one another to form the transfer channel. This construction can be implemented in the simplest manner in technical terms by the core or the two core halves being produced from injection-moldable plastic. “Injection moldable” is understood to mean all plastics or plastics with additions, such as fibers, which can be processed in injection-molding machines.

The surfaces of the core halves adjoining the separating surface can have centering aids which interlock in a complementary manner in the installed state in order to ensure the correct relative position of the core halves to one another. Preferably, the centering aids are designed as positively interlocking structural elements in the form of studs/recesses, grooves/channels. The design of the centering aids as latching or clamping elements is also possible.

In a preferred embodiment, the ball deflectors are arranged in a carrier element. This avoids a subsequent separate assembly of the ball deflectors. The ball deflectors will comprise at least two tongue-shaped blades and two through-openings in (or through) the carrier element.

The carrier element has substantially the basic shape of a cylinder shell, i.e. without considering the ball deflectors. Thus the carrier element corresponds in appearance to a thin curved component, wherein the curvature of the radially external surface of the carrier element corresponds to or matches the curvature of the radially internal surface of the hollow cylinder of the threaded spindle to such an extent that said surfaces can be placed flat against one another. Preferably, the carrier element is produced from metal, for example cut, stamped and bent from a metal sheet. The size is selected such that, on the one hand, it is simple to assemble and cost-effective to manufacture. Further parameters become clear from the following context or the drawings. The carrier element can also have indentations which are provided for saving weight and material without impairing the function or departing from the inventive idea.

The cylindrical surface of the combined core halves will have—in a complementary manner to the carrier element—an indentation which can receive the carrier element such that the carrier element supplements the lateral surface of the core—at least in the regions where the carrier element is positioned on the indentation or recess—to form a regular external cylinder surface again. It should be mentioned that the core or the core halves can have indentations as are generally provided in order to save material and weight. Thus the core can also be designed to be ribbed so that the cylindrical surface virtually results from the envelope of the weight-optimized shape of the core.

The ball deflectors which are arranged on the carrier element are designed as tongue-shaped blades and are thus bulged. They face away from the carrier element or protrude from the curved surface. The bulging is designed such that in each case a blade arches at least partially over a through-opening in or through the carrier element.

In the installed state, the tongue-shaped blades are received in the ball screw drive by the through-passages in the hollow cylinder of the threaded spindle. The blades are dimensioned such that they protrude into the ball race between the spindle nut and threaded spindle and thus guide the balls out of the ball race through the through-openings of the carrier element into the transfer channel or vice versa.

One or more ball screw drives of the type described herein can be used as an actuating element in a brake booster system or as an actuating element in a wheel brake, for example in vehicles and aircraft. The application directly on a brake caliper permits the construction of fully electrical brake systems without recourse to hydraulics.

However, the use is not limited thereto. One or more such ball screw drives can be used as an actuating element in the targeted tracking of a solar panel, a telescope, a tracking apparatus or a lifting or leveling device.

The design described herein of a ball screw drive has its advantages when a ball screw drive is to be implemented with a large diameter for significant actuating loads. On the one hand, the use of an internal deflector keeps the external diameter of the system small, since the transfer channel for the balls does not have to be implemented inside or positioned on the spindle nut. On the other hand, the internal diameter of the inserted core can be used to implement the transfer channel in a large radius between the ball deflectors, which helps to reduce the (rolling) resistance of the balls in the region.

A method for the pre-assembly of a ball screw drive can be described by the following steps:
providing a threaded spindle, a carrier element and a first and second core half,
inserting the carrier element into the cavity of the threaded spindle, wherein:
the bulged tongue-shaped blades are introduced into the through-passages in the hollow cylinder of the threaded spindle, and
the radially external surface of the carrier element is placed flat on the radially internal surface of the hollow cylinder of the threaded spindle,
the first and the second core halves are joined together to form the core,
the core is inserted into the cavity such that the through-openings in the carrier element and the transfer channel in the core form a closed track, and
the core is fixed in the end position by caulking, welding, screwing or by using a support.

These method steps refer to the pre-assembly sequence of the core elements of a ball screw drive in a preferred embodiment. The filling with balls is not described, nor is the assembly of the threaded spindle and spindle nut and the further structural elements required.

As the rolling bodies most commonly used in a ball screw drive, balls are referred to throughout this disclosure. The described principles, however, can also be transferred to other rolling bodies or constructions.

### BRIEF DESCRIPTION OF THE DRAWINGS

The invention is now described by way of example with reference to the accompanying drawings by way of particular preferred embodiments.

FIG. 1 shows a cross section through a ball screw drive 100 according to the prior art.

FIG. 2 shows a threaded spindle 300 in an oblique plan view.

FIGS. 3A and 3B show the separated oblique halves 330, 350 of a core.

FIG. 4 shows the oblique halves 330, 350 combined to form the core 310.

FIG. 5 shows a carrier element 540.

FIG. 6 shows the combination of the carrier element and core 310.

FIG. 7 shows a combination of a threaded spindle 300 with the inserted carrier element 540.

FIG. 8 shows the combination of an individual oblique half 330 with a carrier element 540.

FIG. 9 shows a combination of an individual oblique half 330 with a carrier element 540 in a threaded spindle 200.

### DETAILED DESCRIPTION

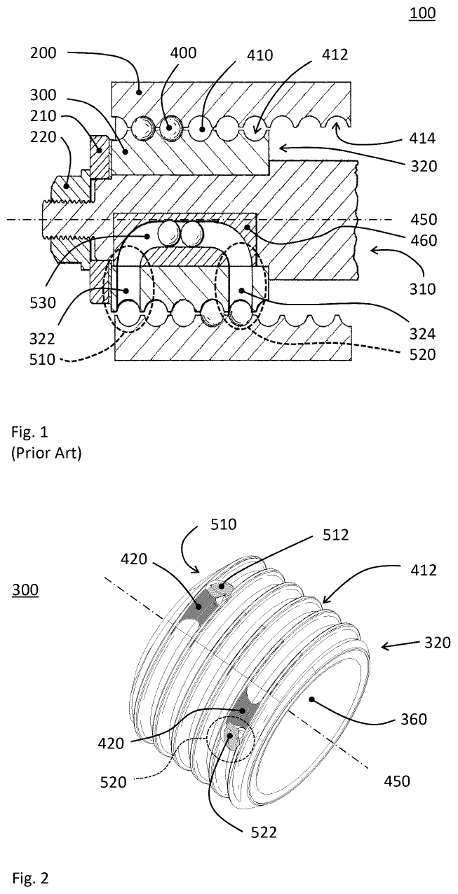

FIG. 1 shows a ball screw drive 100 with an internal deflector (by way of example) in section, in a basic design according to the prior art. The three basic elements from radially outwardly to inwardly toward the central axis 450 are: the spindle nut 200, the threaded spindle 300 and the core 310. The external threaded spindle 200 bears a helical raceway 414 for balls 400 on its hollow cylindrical inner face. The pitch and dimensions of the raceway are complementary to the raceway 412 on the cylindrical outer face of the threaded spindle 300, so that the balls 400 can circulate in the defined intermediate space between the threaded spindle 300 and the spindle nut 200. The opposing complementary raceways 412 and 414 form a helical ball race 410. The threaded spindle 300 is configured here as a hollow cylinder 320 which is filled by a core 310. In the embodiment shown, the core 310 has a step, wherein the diameter which is smaller in terms of diameter is selected such that it matches the internal diameter of the hollow cylinder 320. In the example shown, the hollow cylinder 320 is fixed by means of a washer 210 and a screw connection 220.

The closed recirculation track for the balls 400 is ensured by the two ball deflectors 510, 520 and the connecting transfer channel 530. Two through-passages 322 and 324 in the hollow cylinder 320 ensure the access from the ball race 410 inwardly into the transfer channel 530. This transfer channel is arranged in the direction of the central axis 450 of the ball screw drive 100, implemented here in a separate insert element 460 in the core 310.

FIG. 2 shows an embodiment of a threaded spindle 300 in one possible design for the invention as a hollow cylinder 320. A core, as shown in FIG. 1, is omitted. The cavity is marked by the reference 360. The central axis 450 is shown in the usual manner. The spiral raceway of the balls 412 can be identified on the outer face of the threaded spindle and two ball deflectors 510 and 520. The two tongue-shaped blades 512 and 522, which are parts of the carrier element 540, not visible further here (FIGS. 5, 6), can be seen in the perspective shown. The blades protrude over the through-passages in the hollow cylinder 320. In this case, they are specifically supplemented by inlet or outlet ramps 420 in the raceway 412. As a result, before they are deflected out of the ball race 410 into the ball deflector 510 or 520, the balls are relieved of load and thus slide more easily into the ball deflector.

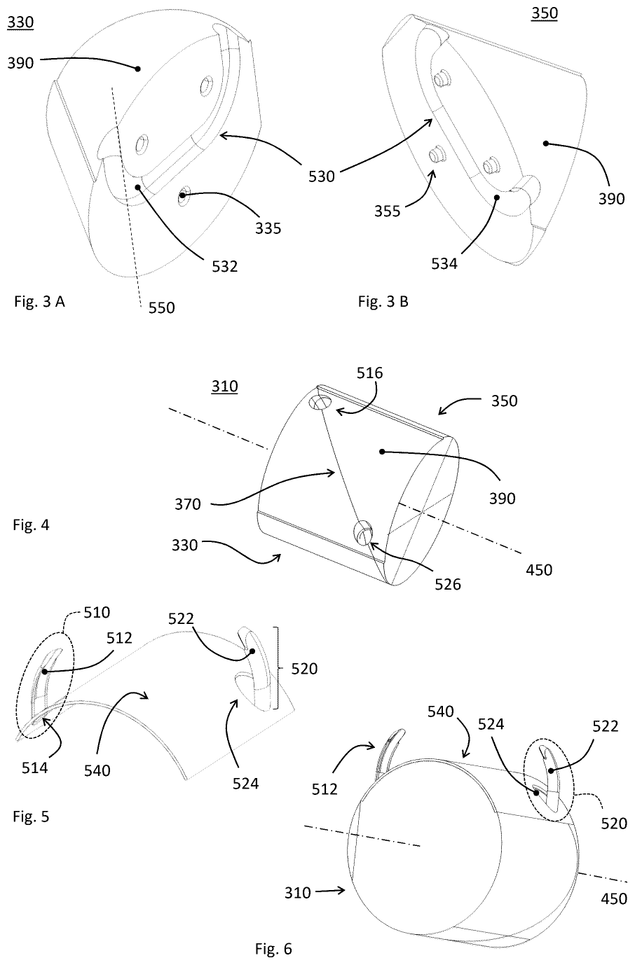

FIGS. 3A and 3B show two oblique halves 330 or 350 individually and FIG. 4 shows the two oblique halves joined together to form a core 310. FIGS. 3A and B show that half of the transfer channel 530 is placed in each case in the cutting plane or separating surface 370 of the oblique halves 330, 350 as half-shell raceways 532, 534. Joined together as a core 310 (FIG. 4), the inlets or outlets 516, 526 which are located exactly in the separating surface 370 are visible. The central axis 450 through the core 310 is shown in turn as a dashed-dotted line.

FIGS. 3A and 3B also show by way of example the centering aids 335 and 355 which assist the orientation of the two oblique halves 330 and 350 in the correct position relative to one another. The indentation 390 which is provided for the carrier element 540 (FIG. 5) is also shown in FIGS. 3A, 3B and 4. The reference sign 550 shows the orientation of the first segment of the transfer channel 530. From the point of view of the balls, the deflection angle from the raceway 412 (FIG. 2) into the transfer channel 532 is greater than 90° since the dashed line 550 forms a secant. If the line 550 were to intersect the central axis 450, the deflection would be oriented substantially radially and the deflection angle would be approximately 90°. If the first portion of the transfer channel 530 were to be placed flat, the deflection angle would be less than 90°.

FIG. 5 shows a carrier element 540 in an embodiment for two ball deflectors. The basic shape of the carrier element 540 as a cylinder shell is clearly visible. The thin curved component, shown here, has been formed from an originally rectangular basic shape but merely represents a preferred embodiment and is not a required design. The bulging or curvature of the cylinder shell is selected, on the one hand, such that the carrier element 540 can be inserted into the indentation 390 of the two section halves 330, 350 joined together to form the core 310. As a result, the indentation 390 is filled such that the core 310 together with the carrier element 540 has a cylinder surface (without considering the tongue-shaped blades 512, 522). This embodiment supports the statement that the curvature of the radially external surface of the carrier element 540 is matched to the curvature of the radially internal surface of the hollow cylinder 320 of the threaded spindle 300 such that said surfaces can be placed flat against one another.

FIG. 5 also shows how the two ball deflectors 510 and 520 are implemented on the carrier element. The ball deflectors comprise in each case a through-opening 514, 524 in the carrier element and tongue-shaped blades 512 and 522 which arch over the respectively assigned through-opening 514, 524.

FIG. 6 can be regarded as a combination of the components of FIGS. 4 and 5. It is shown how a core 310 composed of the oblique halves 330, 350, supplemented by a carrier element 540, can appear in an embodiment according to the invention.

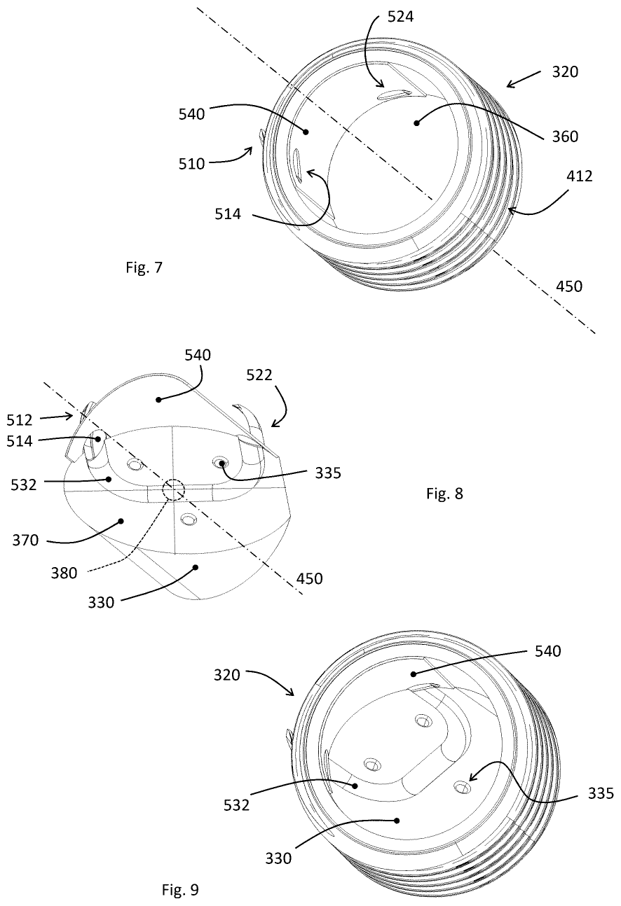

FIG. 7 shows in an oblique view the hollow cylinder 320 of a spindle nut 200 with the inserted carrier element 540. The central axis 450 shows the orientation of the threaded spindle; 412 denotes the raceway of the balls. Through the oblique viewing angle into the cavity 360, it is clear how the curvature of the carrier element 540 is adapted to the internal radius of the hollow cylinder 320. The tip of the tongue-shaped blade of the ball deflector 510 can be identified (not referenced). The two through-openings 514, 524 through the carrier element 540 mark the position of the ball deflectors.

FIG. 8 shows a combination of the first core half 330 with a carrier element 540. The half-shell raceway 532 is shown in the separating area 370/oblique interface of the core half 330. By placing the carrier element 540 against the core half 330, it is ensured that the half-shell raceway 532 is aligned with the through-opening (only shown at 514). The tongue-shaped blades 512, 522 of the ball deflectors are also shown or indicated. FIG. 8 shows, in particular, the feature that the central axis 450 intersects the separating surface 370 or plane between two oblique halves only at one point 380. Only one of the centering aids 335 is marked.

FIG. 9 is a combination of the hollow cylinder 320, a carrier element 540 and a core half 330 or oblique half. All of the aforementioned components are oriented correctly such that the ball deflector is continuous, on the basis of the position of the half-shell raceway 532. A centering aid 335 is marked.

In FIG. 9 it should be noted that the state shown is not an intermediate step of the assembly method.

1. A ball screw drive (100), comprising:
a threaded spindle (300);
a spindle nut (200) which at least partially coaxially encloses the threaded spindle (300);
a plurality of balls (400) which circulate in an intermediate space between the threaded spindle (300) and spindle nut (200) in a helical ball race (410), the helical ball race (410) consisting of two raceways (412, 414) which face one another and which are arranged respectively on an inner face of the spindle nut (200) and an outer face of the threaded spindle (300);
at least one ball return guide with two ball deflectors (510, 520) engaging in the ball race (410), and a transfer channel (530) which runs between the two ball deflectors (510, 520) and which together with a portion of the ball race (410) form a closed recirculation track for the balls (400);
wherein the ball return guide comprises an internal deflector with a transfer channel (530) oriented toward the central axis (450);
the threaded spindle (300) comprises at least in some portions a radially external hollow cylinder (320) with a central symmetrical internal cavity (360) and a cylindrical core (310) filling said cavity (360);
the cylindrical core (310) of the threaded spindle (300) is comprised of a first core half and a second core half (330, 350);
the transfer channel (530) is arranged in a common separating surface (370) of the two core halves (330, 350); and
the first and second core halves (330, 350) comprise oblique halves, the common separating surface (370) thereof forming a plane which intersects the central axis (450) of the core only at one point (380).

2. The ball screw drive (100) as claimed in claim 1, wherein a direction of the deflection of the balls (400) out of the ball race (410) into the transfer channel (530) is substantially configured as a secant (550).

3. The ball screw drive (100) as claimed in claim 1, wherein the hollow cylinder (320) of the threaded spindle (300) has through-passages (322, 324) at locations where the ball deflectors (510, 520) are positioned.

4. The ball screw drive (100) as claimed in claim 1, wherein the transfer channel (530) is constructed from two half-shell raceways (532, 534).

5. The ball screw drive (100) as claimed in claim 1, wherein the core (310) or the first and second core halves (330, 350) are produced from injection-moldable plastic.

6. The ball screw drive (100) as claimed in claim 1, wherein surfaces of the core halves (330, 350) adjoining the separating surface (370) include centering aids (335, 355) which interlock in a complementary manner in an installed state and ensure a relative position of the core halves (330, 350) to one another.

7. The ball screw drive (100) as claimed in claim 1, wherein the ball deflectors (510, 520) are arranged in a carrier element (540) and comprise at least two tongue-shaped blades (512, 522) and two through-openings (514, 524) in the carrier element (540).

8. The ball screw drive (100) as claimed in claim 7, wherein the carrier element (540) has a basic shape of a substantially cylinder shell, a curvature of a radially external surface of the carrier element (540) corresponds to or matches a curvature of a radially internal surface of the hollow cylinder (320) of the threaded spindle (300) to such an extent that said surfaces are adapted to be placed flat against one another.

9. The ball screw drive (100) as claimed in claim 8, wherein the cylindrical surface of the combined first and second core halves (330, 350) has an indentation (390) which is adapted to receive the carrier element (540) such that the carrier element (540) supplements a lateral surface of the core (310) to form a regular external cylinder surface.

10. The ball screw drive (100) as claimed in claim 9, wherein the tongue-shaped blades (512, 522) of the ball deflectors (510, 520) are bulged, face away from the carrier element (540), and in each case arch at least partially over a through-opening (514, 524) through the carrier element (540).

11. The ball screw drive (100) as claimed in claim 10, wherein the hollow cylinder (320) of the threaded spindle (300) has through-passages (322, 324) at locations where the ball deflectors (510, 520) are positioned, and in an installed state, the through-passages (322, 324) in the hollow cylinder (320) of the threaded spindle (300) receive the tongue-shaped blades (512, 522).

12. The ball screw drive (100) as claimed in claim 11, wherein in an assembled state, the tongue-shaped blades (512, 522) protrude into the ball race (410) and form a recirculation track for balls (400) out of the ball race (410) through the through-openings (514, 524) of the carrier element (540) into the transfer channel (530) or vice versa.

13. The ball screw drive (100) as claimed in claim 6, wherein the centering aids (335, 355) comprise positively interlocking structural elements in formed as at least one of studs and recesses, or grooves and channels.

14. The ball screw drive (100) as claimed in claim 13, wherein the centering aids (335, 355) comprise latching or clamping elements.

15. A brake booster system or wheel brake actuator comprising the ball screw drive as claimed in claim 1.

16. An actuating element for targeted tracking of a solar panel, a telescope, a tracking apparatus, a lifting or leveling device comprising the ball screw drives as claimed in claim 1.

17. A method for partial assembly or pre-assembly of a ball screw drive (100), comprising the following steps:
providing a threaded spindle (300) that comprises at least in some portions a radially external hollow cylinder (320), a carrier element (540), and first and second core halves (330, 350);
inserting the carrier element (540) into a cavity (360) of the threaded spindle (300);
introducing bulged tongue-shaped blades (512, 522) of ball deflectors (510, 520) arranged in the carrier element (540) into the through-passages (322, 324) in the hollow cylinder (320) of the threaded spindle (300); and
placing a radially external surface of the carrier element (540) flat on a radially internal surface of the hollow cylinder (320) of the threaded spindle (300);
joining together the first and second core halves (330, 350) to form a core (310)
inserting the core into the cavity such that through-openings (514, 524) in the carrier element (540) and a transfer channel in the core (310) form a closed track; and
fixing the core (310) in an end position by caulking, welding, screwing or by using a support.
